(19) United States
(12) Patent Application Publication
(10) Pub. No.: US 2011/0258624 A1
(43) Pub. Date: Oct. 20, 2011

(54) Virtual machine based secure operating system

(76) Inventor: Fuat Bahadir, Panorama City, CA (US)

(21) Appl. No.: 13/066,567

(22) Filed: Apr. 18, 2011

Related U.S. Application Data
(60) Provisional application No. 61/342,766, filed on Apr. 19, 2010.

(51) Int. Cl. G06F 9/455

(52) U.S. Cl. 718/1

(57) ABSTRACT

Improved computer operating system which is impervious to attack by viruses, hackers and the like and which allow only the operating system to operate on the processor and which creates a virtual machine on which all application software is run.

### RELATED CASES

This invention is described in my copending provisional application Ser. No. 61/342,766, filed, Apr. 19, 2010 and now Apr. 18, 2011.

### FIELD OF INVENTION

This invention relates to computers and is particularly directed to providing improved security for computers.

### BACKGROUND

In recent years, computers have become essential to business and government operations and the security of these computers is critical. However, currently, computer viruses, malware and hacker attacks constitute major threats to personal computers, network servers, hand-held computers, smart phones and the like. The main reason for this is that all software applications can execute code directly on the main processor, or on the virtual machine, at the same level as the operating system. Therefore, it is always possible for an application to take control of the system and abuse the power without awareness of the operating system. Unfortunately, almost all operating systems and application software have bugs in which executing a specific command sequence causes a crash. Commonly computer viruses and hackers first execute a code to cause a crash, which stops the security, then, they take control of the system. Thus, security provided by none of the prior art computer operating systems have been entirely satisfactory.

### BRIEF SUMMARY AND OBJECTS OF INVENTION

These disadvantages of the prior art are overcome with the present invention and a computer operating system model with improved security is provided which is impervious to attack by viruses, hackers and the like.

These advantages of the present invention are preferably attained by providing improved computer operating systems in which only the operating system, that has its own virtual machine, is allowed to directly operate on the processor and all other application software is run by the virtual machine of the operating system.

Accordingly, it is an object of the present invention to provide an improved computer operating system which is impervious to attack by viruses, hackers and the like.

An another object of the present invention is to provide an improved computer operating system which is impervious to attack by viruses, hackers and the like and which allow only virtual machine of the operating system to directly operate on the processor.

A specific object of the present invention is to provide an improved computer operating system which is impervious to attack by viruses, hackers and the like and which allow only virtual machine of the operating system to directly operate on the processor and on which all application software is run.

These and other objects and features of the present invention will be apparent from the following detailed description, taken with reference to the figures of the accompanying drawing.

### BRIEF DESCRIPTION OF THE DRAWING

FIG. 1 is a diagrammatic representation of a prior art computer system; and

FIG. 2 is a diagrammatic representation of a computer system embodying the present invention.

### DETAILED DESCRIPTION OF THE INVENTION

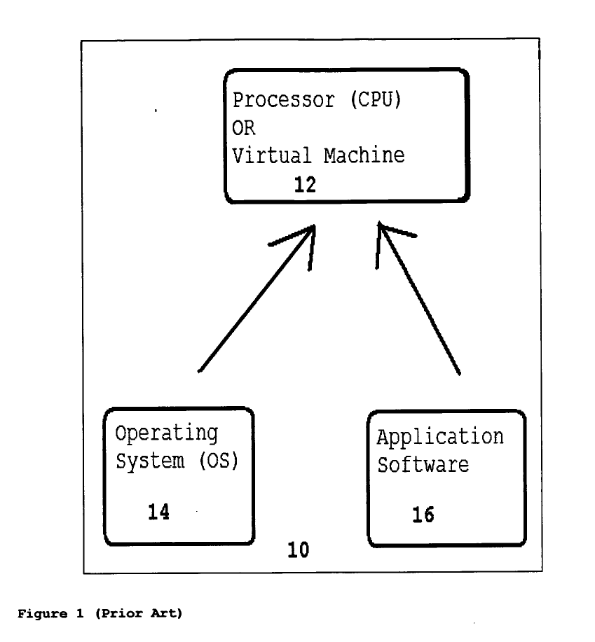

FIG. 1 shows a prior art computer system, indicated generally at 10, having a processor or a virtual machine that runs on the processor 12, and an operating system 14 which runs on the processor or the virtual machine that runs on the processor 12. As shown, all application software 16 is also run on the processor or the virtual machine that runs on the processor 12. Consequently, it is always possible for the application software 16 to take control of the processor or the virtual machine that runs on the processor 12 and to abuse that power without the awareness of the operating system 14. Hackers and viruses take advantage of this weakness to create havoc.

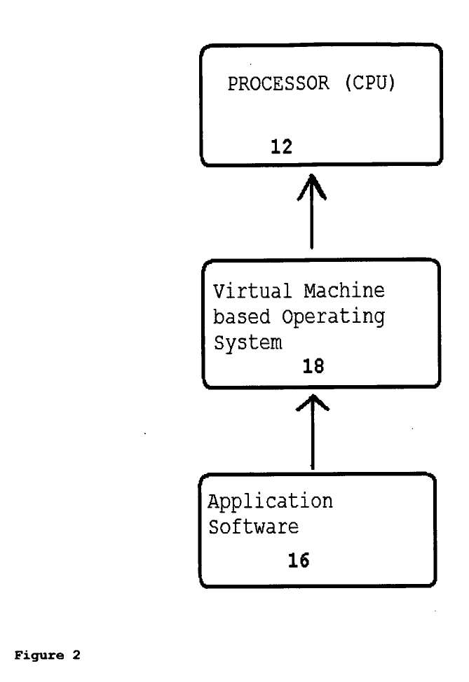

However, this weakness is overcome with the present invention, as seen in FIG. 2, by having an operating system that has its own virtual machine 18, and causing all application software to be run by virtual machine of the operating system 18. In this way, only virtual machine of the operating system 18 is running directly on the processor 12. Virtual machine of the operating system 18, runs the application software 16, by doing a processor simulation in which a set of memory locations are operated similar to registers of a processor 12. If desired, the operating system 18 can create multiple virtual machines instead of only one to achieve a higher degree of multitasking and parallel computing. Furthermore, the virtual machine based operating system 18 can be designed in a way to run any existing software application without the need for a re-design or re-compilation of the application source code, to be backward-compatible. It is also possible for the operating system 18 to create different virtual machines to execute application codes in different languages, such as Java byte-code, or code compiled for different processors and computer platforms, such as Windows, Linux, Mac, smart-phones, and so on.

Preferably, the virtual machine based operating system 18 can have one or more plain text or XML format security policy files, which each contains a set of rules about what actions will be allowed for a specific application software 16, or a specific user, or the operating system itself 18. The virtual machine of the operating system 18 would constantly check the rules as it runs any application code. The user can decide what to allow when installing new application software 16 and the operating system 18 would automatically create security policy rules specific to that application software 16. An application software 16 would never be allowed to modify any security rules or settings of the operating system 18. Only a user who has an enough level of security privileges can modify, a limited set of security rules and settings, by using the tools provided by the operating system itself 18. Furthermore, the operating system 18 would have a basic set of built-in security rules that cannot be modified by any user. For example, an attempt to modify the operating system files 18, or any kind of executable application code file.

The operating system 18 also would have files containing information on which files belong to itself and, preferably, would automatically create and track similar files for each new application software installed. In this way, the operating system 18 would know whenever a running application software 16 tries to modify any file which does not belong to it. Later the virtual machine of the operating system would stop execution of that application code, and inform the user.

Processor simulating virtual machine based computing platforms already exist. However, in the prior art systems, the virtual machine 12 is separate from the operating system 14. Therefore, a malicious application software 16 can still execute code without authorization from the operating system 14 and cause many kinds of damage. The present system precludes this because all file, memory, network communication etc. access requests of any running application must go through the virtual machine of the operating system 18 that runs that application code. Therefore, if the application software 16 tries to do any kind of unauthorized operation, the operating system 18 can easily detect and stop the operation, and optionally also warn the user.

Currently, many kinds of computer viruses, malware and hackers take control of a computer system by taking advantage of software bugs. Almost all existing operating systems and application software have bugs, in which executing a specific command sequence causes a crash. Computer viruses and hackers first execute a code to cause a crash, which stops the security and then, they take control of the system. Newly discovered software bugs force the user to continuously download software patches and updates from the Internet and also to use anti-virus software which also continuously needs to be updated to protect against the latest viruses, etc. In the system of the present invention, the same tactics would not work because, if any running application software 16 crashes, it would simply cause the virtual machine of the operating system 18 to stop execution of that application and notify the user. If the virtual machine itself 18 crashes, then execution of the application software 16 would also stop, since the virtual machine 18 was running the application software 16. Hence, it would be impossible for a malicious application software 16 to take control of the operating system 18 or direct control of the processor 12.

Many new general security rules that apply to all application software, or specific rules for particular application software, or network and Internet access can be added to the operating system 18 later to further enhance security, for example, when large companies, government or military institutions need even higher security in their computer systems. In addition, numerous other variations and modifications can obviously be made without departing from the spirit of the present invention. Therefore, it should be clearly understood that the forms of the present invention described above and shown in the figures of the accompanying drawing are illustrative only and are not intended to limit the scope of the present invention.

What is claimed is:

1. A computer system comprising:
a processor.
an operating system serving said processor,
at least one virtual machine created by said operating system and serving to run all application software.

2. The computer of claim 1 wherein:
said application software is never allowed contact with said processor.

3. The computer of claim 1 wherein:
said virtual machine simulates said processor by creating at least a set of memory locations.

4. The computer of claim 1 wherein:
said operating system can run multiple virtual machines simultaneously.

5. The computer of claim 4 wherein:
said virtual machines can execute code in different computer languages.

6. The computer of claim 4 wherein:
said virtual machines can execute code compiled for different processors.

7. The computer of claim 1 wherein:
said operating system can have at least one security policy file.

8. The computer of claim 1 wherein:
said operating system has files containing information of which files belong to the operating system and any installed application.

9. The computer of claim 1 wherein:
said operating system can detect and stop attempts by said application software to perform an illegal operation.

10. The computer of claim 1 wherein:
said operating system can detect and stop attempts by said application software to perform an illegal operation and can stop said application and warn the user.
